(19) United States
(12) Patent Application Publication
(10) Pub. No.: US 2024/0315477 A1
(43) Pub. Date: Sep. 26, 2024

(54) INFLATABLE EGG APPARATUS

(71) Applicants: Jennifer Couch, Houston, TX (US); Amberly Hall, Houston, TX (US); Kristy Moore, Friendswood, TX (US)

(72) Inventors: Jennifer Couch, Houston, TX (US); Amberly Hall, Houston, TX (US); Kristy Moore, Friendswood, TX (US)

(73) Assignee: Holiball, Inc., Houston, TX (US)

(21) Appl. No.: 18/603,355

(22) Filed: Mar. 13, 2024

Related U.S. Application Data
(60) Provisional application No. 63/491,524, filed on Mar. 21, 2023.

(51) Int. Cl. A47G 33/00; F21V 3/02

(52) U.S. Cl. CPC A47G 33/00; F21V 3/026; A47G 2200/08

(57) ABSTRACT

A holiday apparatus, comprising an inflatable egg shaped globe having an equatorial circumference of between 6 inches and 120 inches and a height of between 6 inches and 60 inches, an aperture that traverses the wall of the inflatable egg shaped globe, the aperture allowing ingress into and egress from the interior of the inflatable egg shaped globe; and a closure mechanism that securely couples to the aperture into the inflatable egg shaped globe operable to retain air in the inflatable egg shaped globe when closed.

### CROSS REFERENCE TO RELATED APPLICATION

This application claims the benefit of U.S. Provisional Application No. 63/491,524, filed Mar. 21, 2023, the contents of which are incorporated herein.

### TECHNICAL FIELD

The present invention relates to decorative holiday ornaments.

### BACKGROUND OF THE INVENTION

The tradition of dyeing eggs and associating them with Easter has ancient roots and is influenced by various cultural and religious practices over time. One theory suggests that the tradition of dyeing eggs predates Christianity and may have originated with pagan spring festivals, where eggs symbolized fertility, rebirth, and new life. These festivals often celebrated the arrival of spring and the end of winter, with eggs representing the renewal of life and the return of sunlight. As Christianity spread throughout Europe, it incorporated and adapted many pre-existing customs and symbols into its own religious observances. In the case of Easter, which commemorates the resurrection of Jesus Christ, the symbolism of eggs was gradually incorporated into Christian traditions. During Lent, the 40-day period of fasting and reflection leading up to Easter Sunday, Christians historically abstained from consuming eggs and other animal products. Therefore, eggs became a common food item to be consumed again on Easter Sunday, symbolizing the end of Lenten fasting and the joy of the resurrection. The practice of dyeing eggs may have originated as a way to distinguish between eggs that were laid during Lent, which were set aside and not consumed until Easter, and fresh eggs laid after the fasting period. Additionally, the act of dyeing eggs in vibrant colors may have symbolized the joy and celebration of Easter.

Over time, the tradition of dyeing Easter eggs became widespread across Christian communities, with various cultures developing their own techniques and styles of egg decoration. Today, decorating eggs remains a popular Easter tradition in many parts of the world, symbolizing the themes of rebirth, renewal, and the arrival of spring.

Easter decorations are made of blown glass, metal, wood, blown plastics, expanded polystyrene and/or ceramics. Such decorations are almost always reused year after year rather than purchased annually, and family collections often contain a combination of commercially produced ornaments and decorations created by family members. Often such holiday decorations are small in size, having circumference of between 2 inches and 5 inches.

What is desired is a much larger decoration in an Easter egg shape made of a resilient material that is capable of being deployed in the outdoors in yards or on trees, and which can be internally illuminated. The invention comprises such a decoration.

### SUMMARY OF THE INVENTION

The invention is an inflatable, resilient, plastic polymer egg shaped globe having an equatorial circumference in the range of 6 inches and 120 inches for use as a holiday decoration. The invention can be deflated to allow efficient storage. The invention has several components including the inflatable egg shaped globe and a closure mechanism. In an embodiment, the closure mechanism is a ribbed or threaded plug operable to be inserted into an aperture which permits air ingress into and egress out of the inflatable egg globe. Further, the invention includes a plurality of equally spaced protrusions around a circumference at the base of the inflatable egg globe operable to keep the invention upright. In one aspect, the aperture is located at or near the bottom or base of the inflatable egg globe.

The geometric shape of the inflatable egg globe is a smooth prolate ellipsoid or spheroid having a three-dimensional shape characterized by an oval shape with no sharp edges or corners. In an embodiment, the invention further comprises a light source operable to illuminate the inflatable egg shaped globe. While the invention is directed for use as an Easter decoration, it can be used for other occasions.

To those skilled in the art to which this invention relates, many changes in construction and widely differing embodiments and applications of the invention will suggest themselves without departing from the scope of the invention as defined herein. The disclosures and the descriptions herein are purely illustrative and are not intended to be in any sense limiting.

### BRIEF DESCRIPTION OF THE DRAWINGS

For a better understanding of the present invention including the features, advantages and specific embodiments, reference is made to the following detailed description along with accompanying Figures, in which:

FIG. 1 is a side-view of an embodiment of the invention;

FIG. 2 is a bottom view of an embodiment of the invention;

FIG. 3 is a perspective view of the bottom of an embodiment of the invention;

FIG. 4 is a view of a ribbed plug used as a part of a closure mechanism; and

FIG. 5 is a view of a ribbed plug with a light source used as part of a closure mechanism.

### DETAILED DESCRIPTION

While the making and using of the disclosed embodiments of the present invention is discussed in detail below, it should be appreciated that the present invention provides many applicable inventive concepts which can be embodied in a wide variety of specific contexts. Some features of the preferred embodiments shown and discussed may be simplified or exaggerated for illustrating the principles of the invention.

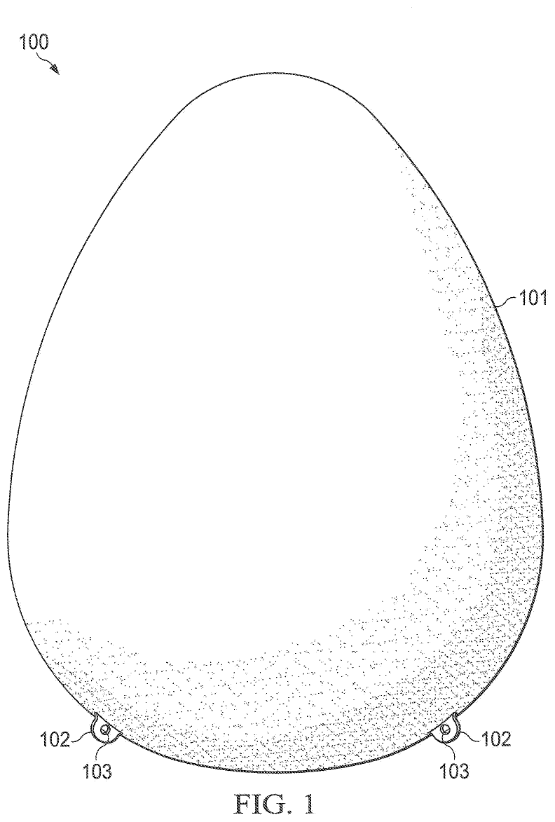

Referring now to the Figures, FIG. 1 is a side-view of a first embodiment of the invention 100. The invention 100 is a holiday apparatus, comprising an inflatable egg shaped globe portion 101 having an equatorial circumference of between 6 inches and 120 inches and a height of between 6 inches and 60 inches. The inflatable egg shaped globe 101 has a plurality of protrusions or feet 102 proximate the base or lower portion of the inflatable egg shaped globe 101, said protrusions having protrusion apertures 103 traversing through the planar surfaces thereof.

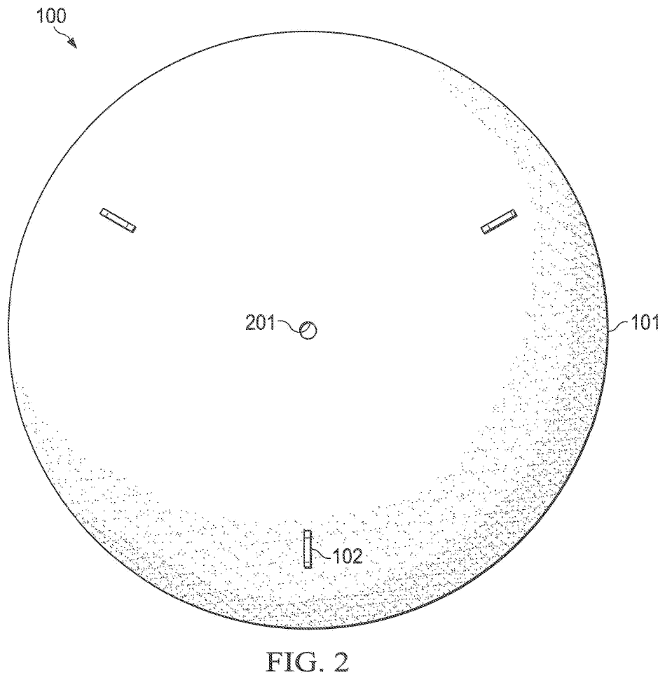

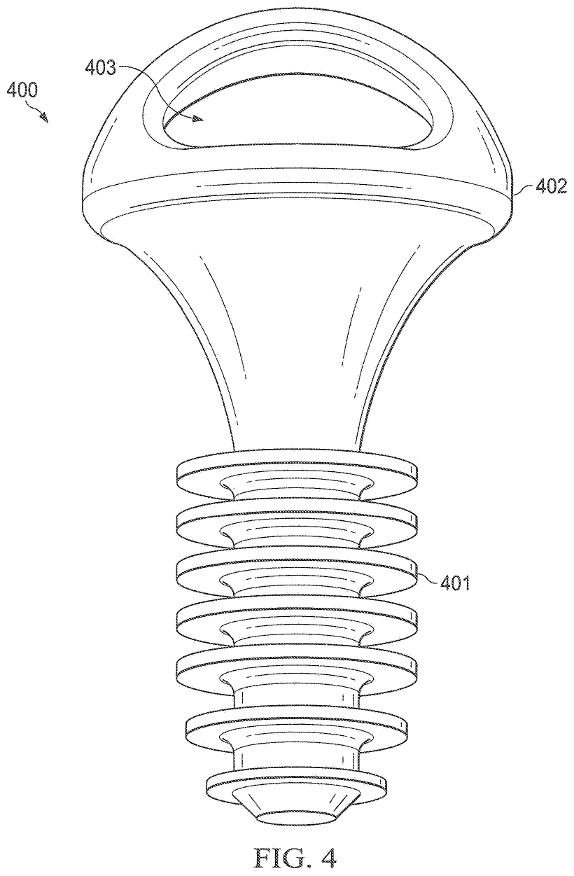

FIG. 2 is a bottom view of the first embodiment of the invention 100 showing inflatable egg shaped globe portion 101 having an equatorial circumference of between 6 inches and 120 inches and a height of between 6 inches and 60 inches. Closure mechanism comprises a plug 400 (as seen in FIG. 4) and aperture 201. The closure mechanism is operable to retain air in the inflatable egg shaped globe 101. Aperture 201 traverses the wall of the inflatable egg shaped globe 101, the aperture 201 operable to allow ingress into and egress from the interior of the inflatable egg shaped globe 101.

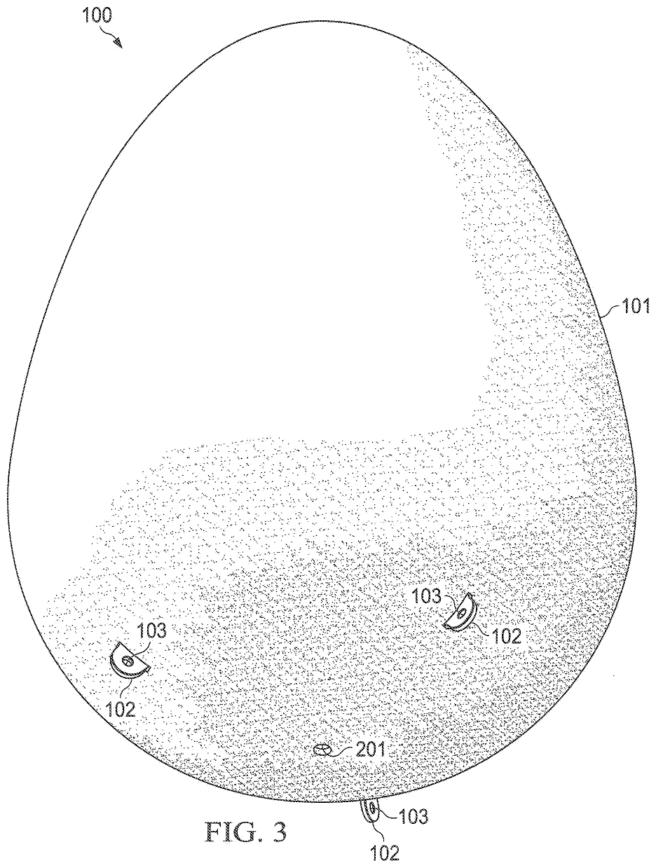

FIG. 3 is a perspective, bottom view of an embodiment of the invention 100. Aperture 201 traverses the wall of the inflatable egg shaped globe 101, the aperture 201 operable to allow ingress into and egress from the interior of the inflatable egg shaped globe 101. The inflatable egg shaped globe 101 has a plurality of protrusions or feet 102 proximate the base or lower portion of the inflatable egg shaped globe 101, said protrusions having protrusion apertures 103 traversing through the planar surfaces thereof. As seen in FIG. 3, three protrusions or feet 102 are arranged around a lower circumference of the inflatable egg shaped globe 101.

Egg or egg shaped as used herein refers to an ovoid and includes egg-shaped, elliptic, elliptical, ellipsoid, oval, oval-shaped, ovate, oviform, prolate or rounded. Measuring an ellipsoid involves determining its dimensions along the three principal axes: the semi-major axis (a), the semi-minor axis (b), and the semi-intermediate axis (c). These axes define the shape of the ellipsoid and can be used to calculate its volume, surface area, and other geometric properties. An embodiment of the invention 100 is as a prolate spheroid. The semi-major axis (a) is the longest radius of the ellipsoid, while the semi-minor axis (b) is the shortest radius perpendicular to the semi-major axis. The semi-intermediate axis (c) is the remaining axis perpendicular to both the semi-major and semi-minor axes.

The invention 100 is a holiday apparatus, comprising an inflatable egg shaped globe portion 101 having an equatorial circumference of between 6 inches and 120 inches and a height of between 6 inches and 60 inches. Closure mechanism is a plug 400 and aperture 201 operable to retain air in the inflatable egg shaped globe. Aperture 201 traverses the wall of the inflatable egg shaped globe 101, the aperture 201 operable to allow ingress into and egress from the interior of the inflatable egg shaped globe 101. The inflatable egg shaped globe 101 has a plurality of protrusions 102 proximate the lower portion of the inflatable egg shaped globe 101, said protrusions having protrusion apertures 103 traversing through the planar surfaces thereof. The protrusions 102 are operable to stabilize the invention 100, the protrusion apertures 103 are operable allow the threading of string, wire or rope therethrough, the string, wire or rope to be tied to a stake or other anchoring mechanism. The invention 100 is also claimed in combination with an anchor system.

FIG. 4 is a view of a plug 400 used as part of the closure mechanism. An embodiment of the plug 400 has a ribbed portion 401 and a top portion 402 having an aperture 403 therethrough. Alternatively, plug 400 can have a threaded portion that mates with a corresponding threaded portion within invention 100, the aperture 201 being operable to receive ribbed portion 401 or threaded portion of the plug.

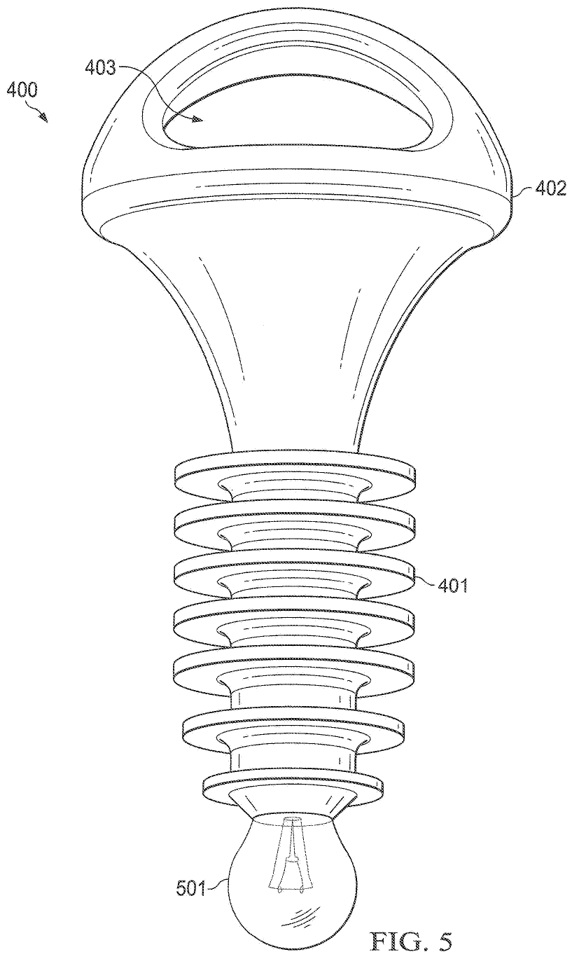

FIG. 5 is another view of a plug 400 used as part of the closure mechanism. Plug 400 has a ribbed portion 401, a top portion 402 having an aperture 403 therethrough and a light source 404 coupled thereto. The interior of plug 400 can have a hollow portion with associated circuitry and switch(es) operable to power light source 404.

The invention is a holiday apparatus, comprising an inflatable egg shaped globe having an equatorial circumference of between 6 inches and 120 inches and a height of between 6 inches and 60 inches; an aperture that traverses the wall of the inflatable egg shaped globe, the aperture allowing ingress into and egress from the interior of the inflatable egg shaped globe; and a closure mechanism that securely couples to the aperture into the inflatable egg shaped globe operable to retain air in the inflatable egg shaped globe when closed.

The inflatable egg shaped globe is made of a resilient polymer material. The inflatable egg shaped globe more specifically is a three-dimensional spheroid shape characterized by an oval shape with no sharp edges or corners, said inflatable egg shaped globe having a plurality of protrusions proximate the lower portion of the inflatable egg shaped globe, said protrusions having protrusion apertures traversing through the planar surfaces thereof.

The closure mechanism comprises a plug. The aperture is an inwardly cylindrical portion of the inflatable egg shaped globe which extends into the interior of the inflatable egg shaped globe and the closure mechanism is a plug that is received into the aperture. In an embodiment, the plug is ribbed. In a further embodiment, the plug is threaded.

The invention further includes a light source for illuminating the interior of the inflatable egg shaped globe. In an embodiment, the light source is coupled to an end of the plug. The light source can be a Light-Emitting Diode (LED). The LED can be controlled by either a local switch, a wired controller or a wireless controller. The light source can be powered by one selected from the group consisting of an internal battery, external battery unit and solar panel. In an embodiment, the inflatable egg shaped globe is a translucent pastel color and wherein the light source is emits a white color.

In an embodiment, the closure mechanism includes a plug having a cylindrical rod portion and a top portion having an aperture therethrough, the cylindrical rod portion having helical ridges (threads) spiraling around its length on its outer surface wherein the threads are uniformly spaced and are designed to match with corresponding threads in the inwardly cylindrical portion of the inflatable egg shaped globe which extends into the interior of the inflatable egg shaped globe. The inflatable egg shaped globe is a resilient polymer material having incorporated into the material dye or coloring.

The invention further is a decorative holiday apparatus, comprising an inflatable egg shaped globe made of a resilient polymer material having a colored surface and having an equatorial circumference of between 6 inches and 120 inches; an opening that coaxially traverses the wall of the inflatable egg shaped globe, the opening allowing ingress into and egress from the interior of the inflatable egg shaped globe; and a closure mechanism that securely couples to the opening into the inflatable egg shaped globe operable to retain air in the inflatable egg shaped globe when closed. The inflatable egg shaped globe has a spheroid portion and is made of a resilient polymer material and the closure mechanism comprises a plug and a corresponding inwardly cylindrical portion of the inflatable egg shaped globe which extends into the interior of the inflatable egg shaped globe, the plug operable to mate with the inwardly cylindrical portion so as to retain air in the inflatable egg shaped globe when it is closed.

The invention is an inflatable, resilient, plastic polymer ellipsoid, oval or egg shaped globe for use as a holiday decoration. More specifically, the invention is a holiday apparatus, comprising an inflatable ellipsoid, oval or egg shaped globe with an equatorial circumference of between 6 inches and 120 inches and a height of between 6 inches and 60 inches with an opening allowing ingress into and egress from the interior of the ellipsoid, oval or egg globe. A closure mechanism securely couples to opening into the inflatable ellipsoid, oval or egg globe thus restricting the egress of air from the inflatable ellipsoid, oval or egg globe. Without limiting the materials used to make the invention in an embodiment, the inflatable globe is made of a resilient polymer material. The opening into the inflatable ellipsoid, oval or egg globe can be a cylindrical orifice being a conduit into the interior of the ellipsoid, oval or egg globe.

The closure mechanism couples to the attachment pin at the top of the inflatable ellipsoid, oval or egg globe. Alternatively, the opening is an inwardly cylindrical portion of the inflatable ellipsoid, oval or egg globe that extends into the interior of the inflatable ellipsoid, oval or egg globe and the closure mechanism is a plug that is received into the opening. In an embodiment, the interior of the closure mechanism can include a valve operable to be closed when it is in its default position and then opened when pressure or force is applied to a portion thereof.

A light source can be located at an end of said plug, said light source being a compact electric light source such as a Light-Emitting Diode and powered by one from the group consisting of an internal battery, external battery unit and solar panel via wires extending through said attachment pin. Further, the closure mechanism can comprise a threaded portion configured to be coupled to the integrated attachment pin. The inflatable ellipsoid, oval or egg globe can be any color, preferably a pastel color for the egg, and can be monochromatic or having a pattern of a plurality of colors.

The invention further comprises an inflatable ellipsoid, oval or egg globe having a generally ellipsoid, oval or egg shape an equatorial circumference of between 6 inches and 120 inches and a height of between 6 inches and 60 inches and an opening into the interior of the globe located at the bottom of said inflatable ellipsoid, oval or egg globe. A removable ribbed plug is configured to be received into the opening into said ellipsoid, oval or egg globe, the ribbed plug having stopper near its terminal end, and an aperture at its upper end, the ribbed plug operable to maintain air pressure in said inflatable ellipsoid, oval or egg globe when inserted.

This embodiment of the invention further comprises a light source at a distal end of said removable ribbed plug, said light source being a compact electric light source such as a Light-Emitting Diode and wherein said light source is powered by one from the group consisting of an internal battery in the plug. external battery unit and solar panel via wires extending through said plug. A further embodiment of the invention is an inflatable holiday apparatus, comprising an inflatable ellipsoid, oval or egg globe with an attachment pin, said attachment pin extending a short distance through a threaded or ridged opening on the top of said inflatable ellipsoid, oval or egg globe such that one end of said attachment pin defined as the interior end is inside said ellipsoid, oval or egg globe when assembled, said attachment pin comprising a threaded section corresponding to said threaded or ridged opening on the top or bottom of said inflatable ellipsoid, oval or egg globe. Said embodiment further includes a hanger, and a light source at said interior end of said attachment pin, said light source being a compact electric light source such as a Light-Emitting Diode wherein said light source is powered by one from the group consisting of an internal battery, external battery unit and solar panel via wires extending through said attachment pin.

An advantage of the invention is that it can be inflated to a diameter of several inches or feet and then be deflated after use to allow for efficient storage. The invention includes an ultraviolet (UV) resistant coating, and is durable for use in any weather condition. The invention is preferably inflated with an electric fast flow inflator.

More generally, the invention is a holiday apparatus comprising an inflatable ellipsoid, oval or egg globe having a generally round shape an equatorial circumference of between 6 inches and 120 inches and a height of between 6 inches and 60 inches. When plugged, the ellipsoid, oval or egg globe is impervious to the release of air that is injected therein prior to plugging. An attachment pin is attached or coupled to the top or bottom of the globe for accepting a closure mechanism. A hanger can be threaded through an orifice at the end of the closure mechanism.

The inflatable ellipsoid, oval or egg globe is preferably made of a resilient polymer material. The hanger that is threaded through the plug is made from a material selected from the group consisting of steel, plastic, string, cord or similar material. The ellipsoid, oval or egg globe is monochromatic or can be comprised of a plurality of colors. Preferably, the egg globe is primarily a pastel color.

In an embodiment the inflatable ellipsoid, oval or egg ball further comprises an electronic light such as an LED suspended therein, said light being powered by a replaceable or rechargeable battery, or solar panel or other external power source. In an embodiment, said light is coupled to a switch and can be set to on or off. In another embodiment, said light is coupled via a wireless receiver to a remote control and can be set to on or off using said remote. In a further embodiment, the inflatable ellipsoid, oval or egg ball comprises multiple lights such as LEDs suspended therein, said lights emitting different or varied colors, and the desired emitted light color can be controlled via said switch or remote by mixing the intensity of the individual lights.

The invention is a holiday apparatus, comprising an inflatable ellipsoid, oval or egg globe having a generally round shape an equatorial circumference of between 6 inches and 120 inches and a height of between 6 inches and 60 inches; an opening allowing ingress into and egress from the interior of the globe; a closure mechanism that securely couples to opening into the inflatable ellipsoid, oval or egg globe thus restricting the egress of air from the inflatable globe. The inflatable ellipsoid, oval or egg globe is made of a resilient polymer material. The opening is a cylindrical orifice being a conduit into the interior of the ellipsoid, oval or egg globe and the closure mechanism is a removable ribbed plug configured to be received into the opening in the top of said ellipsoid, oval or egg globe, said ribbed plug having stopper near its terminal end, and an aperture at its upper end, the ribbed plug operable to maintain air pressure in said inflatable ellipsoid, oval or egg globe when inserted. The opening is an inwardly cylindrical portion of the inflatable ellipsoid, oval or egg globe that extends into the interior of the inflatable globe and the closure mechanism is a ribbed plug that is received into the opening. The invention further comprises a light source at an end of said plug, said light source being a compact electric light source such as a Light-Emitting Diode. Said light source is powered by one from the group consisting of an internal battery, external battery unit and solar panel via wires extending through said ribbed plug. In an embodiment, the closure mechanism is threaded and the hanger is a closed loop made from one selected from the group consisting of steel, plastic, string, and cord.

In a further embodiment, a light source such as a light emitting diode can be positioned at the end of the plug and powered by an internal or external power source. The inflated ornament can then be illuminated and hung to a tree or tethered to the ground. The illumination is further adapted to be controlled by a local switch or timer. Illumination can also be controlled by a remote device such as a standalone unit or smartphone running a dedicated application, control signals being sent to electronics integrated into said attachment pin by wireless means such as 2.4 GHz radio or Bluetooth™, said integrated electronics including a receiving antenna, non-volatile memory, and processor capable of running a program in the form of instructions stored in said memory.

In an embodiment the inflatable ball further comprises an electronic light such as an LED suspended therein, said light being powered by a replaceable or rechargeable battery, or solar panel or other external power source. In an embodiment, said light is coupled to a switch and can be set to on or off. In another embodiment, said light is coupled via a wireless receiver to a remote control and can be set to on or off using said remote. In a further embodiment, the inflatable ball comprises multiple lights such as LEDs suspended therein, said lights emitting different or varied colors, and the desired emitted light color can be controlled via said switch or remote by mixing the intensity of the individual lights.

In an embodiment, the invention is a holiday apparatus, comprising an inflatable egg shaped globe; an aperture through the wall of the inflatable egg shaped globe operable to allow ingress into and egress from the interior of the inflatable egg shaped globe; and a plug operable to be received in the aperture so as to retain air in the inflatable egg shaped globe. The inflatable egg shaped globe is made of a resilient polymer material. The inflatable egg shaped globe is defined by an oval spheroid shape with no sharp edges or corners. The inflatable egg shaped globe has an equatorial circumference of between 6 inches and 120 inches and a height of between 6 inches and 60 inches.

The plug and aperture comprise a closure mechanism. The closure mechanism further comprises an inwardly cylindrical portion of the inflatable egg shaped globe which extends into the interior of the inflatable egg shaped globe, the aperture defining the opening thereof, the plug thus being received into the aperture and then the inwardly cylindrical portion. In an embodiment the plug is ribbed. In another embodiment, the plug is threaded. The plug further includes a light source for illuminating the interior of the inflatable egg shaped globe. In an embodiment, the light source is coupled to an end of the plug. The inflatable egg shaped globe is a translucent pastel color and wherein the light source emits a white color. In an embodiment, the light source is a Light-Emitting Diode (LED) wherein the LED is controlled by either a local switch, a wired controller or a wireless controller. Said light source is powered by one selected from the group consisting of an internal battery, external battery unit and solar panel. In an embodiment, said light source is powered by an internal battery that is included within a hollow portion of the plug.

The invention is a holiday apparatus, comprising an inflatable egg shaped globe; a closure mechanism being a plug and an inwardly cylindrical portion with an opening, the inwardly cylindrical portion extending into the interior of the inflatable egg shaped globe; the plug being a cylindrical rod portion and a top portion having an aperture therethrough, the cylindrical rod portion having helical ridges (threads) spiraling around its length on its outer surface wherein the threads are uniformly spaced and are designed to match with corresponding threads in the inwardly cylindrical portion. The inflatable egg shaped globe is a resilient polymer material having incorporated into the material dye or coloring.

The invention is a decorative holiday apparatus, comprising an inflatable egg shaped globe made of a resilient polymer material having a colored surface and having an equatorial circumference of between 6 inches and 120 inches and a height of between 6 inches and 60 inches; an opening that coaxially traverses the wall of the inflatable egg shaped globe, the opening allowing ingress into and egress from the interior of the inflatable egg shaped globe; and a closure mechanism that securely couples to the opening into the inflatable egg shaped globe operable to retain air in the inflatable egg shaped globe when closed. The inflatable egg shaped globe has a spheroid portion is made of a resilient polymer material. The closure mechanism comprises a plug and a corresponding inwardly cylindrical portion of the inflatable egg shaped globe which extends into the interior of the inflatable egg shaped globe, the plug operable to mate with the inwardly cylindrical portion so as to retain air in the inflatable egg shaped globe when it is closed.

The embodiments shown and described above are only exemplary. Even though numerous characteristics and advantages of the invention have been set forth in the foregoing description, the disclosure is illustrative only and changes may be made within the principles of the invention to the full extent indicated by the broad general meaning of the terms used herein. Various alterations, modifications and substitutions can be made to the disclosed invention without departing in any way from the spirit and scope of the invention.

The invention claimed is:

1. A holiday apparatus, comprising
an inflatable egg shaped globe;
an aperture through the wall of the inflatable egg shaped globe operable to allow ingress into and egress from the interior of the inflatable egg shaped globe; and
a plug operable to be received in the aperture so as to retain air in the inflatable egg shaped globe.

2. The holiday apparatus of claim 1, wherein the inflatable egg shaped globe is made of a resilient polymer material.

3. The holiday apparatus of claim 1, wherein the inflatable egg shaped globe is defined by an oval spheroid shape with no sharp edges or corners.

4. The holiday apparatus of claim 1, wherein the inflatable egg shaped globe has an equatorial circumference of between 6 inches and 120 inches and a height of between 6 inches and 60 inches.

5. The holiday apparatus of claim 1, wherein the plug and aperture comprise a closure mechanism.

6. The holiday apparatus of claim 5, further comprising an inwardly cylindrical portion of the inflatable egg shaped globe which extends into the interior of the inflatable egg shaped globe, the aperture defining the opening thereof, the plug thus being received into the aperture and then the inwardly cylindrical portion.

7. The holiday apparatus of claim 6, wherein the plug is ribbed.

8. The holiday apparatus of claim 6, wherein the plug is threaded.

9. The holiday apparatus of claim 1, wherein the plug further includes a light source for illuminating the interior of the inflatable egg shaped globe.

10. The holiday apparatus of claim 9, wherein the light source is coupled to an end of the plug.

11. The holiday apparatus of claim 10, wherein the inflatable egg shaped globe is a translucent pastel color and wherein the light source emits a white color.

12. The holiday apparatus of claim 10, wherein the light source is a Light-Emitting Diode (LED).

13. The holiday apparatus of claim 12, wherein the LED is controlled by either a local switch, a wired controller or a wireless controller.

14. The holiday apparatus of claim 13, wherein said light source is powered by one selected from the group consisting of an internal battery, external battery unit and solar panel.

15. The holiday apparatus of claim 10, wherein said light source is powered by an internal battery that is included within a hollow portion of the plug.

16. A holiday apparatus, comprising
an inflatable egg shaped globe;
a closure mechanism being a plug and an inwardly cylindrical portion with an opening, the inwardly cylindrical portion extending into the interior of the inflatable egg shaped globe; and
the plug being a cylindrical rod portion and a top portion having an aperture therethrough, the cylindrical rod portion having helical ridges (threads) spiraling around its length on its outer surface wherein the threads are uniformly spaced and are designed to match with corresponding threads in the inwardly cylindrical portion.

17. The holiday apparatus of claim 16, wherein the inflatable egg shaped globe is a resilient polymer material having incorporated into the material dye or coloring.

18. A decorative holiday apparatus, comprising
an inflatable egg shaped globe made of a resilient polymer material having a colored surface and having an equatorial circumference of between 6 inches and 120 inches and a height of between 6 inches and 60 inches;
an opening that coaxially traverses the wall of the inflatable egg shaped globe, the opening allowing ingress into and egress from the interior of the inflatable egg shaped globe; and
a closure mechanism that securely couples to the opening into the inflatable egg shaped globe operable to retain air in the inflatable egg shaped globe when closed.

19. The decorative holiday apparatus of claim 18, wherein the inflatable egg shaped globe has a spheroid portion is made of a resilient polymer material.

20. The decorative holiday apparatus of claim 19, wherein the closure mechanism comprises a plug and a corresponding inwardly cylindrical portion of the inflatable egg shaped globe which extends into the interior of the inflatable egg shaped globe, the plug operable to mate with the inwardly cylindrical portion so as to retain air in the inflatable egg shaped globe when it is closed.
